(19) United States
(12) Patent Application Publication
(10) Pub. No.: US 2006/0130346 A1
(43) Pub. Date: Jun. 22, 2006

(54) Laser marking and chase-setting device

(76) Inventor: Brian Robert Bogison, Bozeman, MT (US)

Correspondence Address: BRIAN R. BOGISON, 560 GOES NOWHERE ROAD, BOZEMAN, MT, 59715, US

(21) Appl. No.: 11/293,721

(22) Filed: Feb. 24, 2006

Related U.S. Application Data
(60) Provisional application No. 60/633,057, filed on Dec. 3, 2004.

(51) Int. Cl. G01C 15/00

(52) U.S. Cl. 33/286

(57) ABSTRACT

A laser marker disposable on a reference surface having a cylindrical housing, a suitable power pack, and a laser diode and lens within the housing for generating a point of measurement.

### CROSS-REFERENCE TO RELATED APPLICATIONS:

This application claims the benefit of provisional patent application Ser. No. 60/633,057, filed 2004 Dec. 03 by the present inventor.

FEDERALLY-SPONSORED RESEARCH

Not Applicable

SEQUENCE LISTING OR PROGRAM

Not Applicable

### BACKGROUND OF THE INVENTION—FIELD OF THE INVENTION

This invention relates to laser tools, specifically to such devices which are used to mark lines, points, and planes in the building trades and other manufacturing.

### BACKGROUND OF THE INVENTION—PRIOR ART

Laser tools facilitate a wide variety of projects in construction and manufacturing. Such devices come in many shapes and sizes and normally fit into one of a few categories. Some laser tools produce a plane of light for identifying level lines and benchmarks. This type of laser tool is used extensively in excavation, foundation work, and framing. Other laser tools spread light through a special lens that generates a fixed line. The housing for this type of laser tool can be adjusted to identify either level lines or plumb lines in place of conventional chalk lines and torpedo levels. Fixed line tools are especially useful in tile work and finish carpentry.

The type of laser tool most similar to the present invention produces a single point of light. It is the laser equivalent of a plumb bob. The problem with the laser plumb bob is that it has the same limited number of uses as a conventional plumb bob. The laser plumb bob only delineates vertical measurements. It is ill-suited for marking out horizontal measurements of any substantive value.

### BACKGROUND OF THE INVENTION - OBJECTS AND ADVANTAGES

Accordingly, besides the objects and advantages of the laser tool described in my provisional patent application, several objects and advantages of the present invention are:

(A) to provide a new type of laser tool which can used in tight spaces for marking out horizontal, sloped, and vertical points of measurement;

(B) to provide a tool specifically designed for electricians, plumbers, and other tradesmen who regularly have to chase utilities in buildings;

(C) to provide a tool which adapts and couples into the ends of different pipe sizes, clearly delineating the next obstruction that must be drilled or cut for the chase;

(D) to provide a tool which greatly facilitates the task of excavating and setting septic tanks on slope, giving the installer a simple way of shooting grade prior to delivery.

Further objects and advantages are to provide a laser tool which makes it substantially easier to chase electrical wire, pipe, and other utilities in buildings, which saves the tradesman considerable time and effort in the layout of a job, and which produces a variety of new measurements that existing laser tools do not.

### SUMMARY

In accordance with the present invention a laser tool comprising a laser diode, a suitable power pack, and a housing which is specifically designed for chasing utilities.

1. In a laser tool of the type comprising a housing and at least one laser diode disposed in said housing, the improvement wherein said housing is adaptable to horizontal sloped, and vertical settings.

2. The laser tool of claim 1 wherein said housing has a suitable battery pack.

3. The laser tool of claim 1 wherein said laser diode generates a visible beam of light.

4. The laser tool of claim 3 wherein said beam of light is dispersed through a central aperture and focusing lens that generates a suitable point of light on a reference surface.

5. The laser tool of claim 1 wherein said housing can be cylindrically adapted to sleeve into holes of varying sizes.
